(19) United States
(12) Patent Application Publication
(10) Pub. No.: US 2025/0105894 A1
(43) Pub. Date: Mar. 27, 2025

(54) Beamforming Control for Downlink Limited Access Node

(71) Applicant: Telefonaktiebolaget LM Ericsson (publ), Stockholm (SE)

(72) Inventors: Niklas Wernersson, Kungsängen (SE); Anders Furuskär, Stockholm (SE); Andreas Nilsson, Göteborg (SE)

(21) Appl. No.: 18/725,612

(22) PCT Filed: Jan. 4, 2022
(86) PCT No.: PCT/EP2022/050074

§ 371 Date: Jun. 28, 2024

(51) Int. Cl. H04B 7/06; H04L 5/00; H04L 25/02

(52) U.S. Cl. CPC H04B 7/0619; H04L 5/0048; H04L 25/0224

(57) ABSTRACT

An access node (102), which may be limited with respect to its capability of performing downlink wireless transmissions, cooperates with another access node (101) to enable beamformed uplink wireless transmissions from a wireless device (10) to the access node (102) and/or to assist the other access node (101) in performing beamformed downlink wireless transmissions to a UE.

### TECHNICAL FIELD

The present invention relates to methods for controlling wireless transmissions and to corresponding devices, systems, and computer programs.

### BACKGROUND

In wireless communication networks, e.g., based on the 4G (4^{th} Generation) LTE (Long Term Evolution) or 5G (5^{th} Generation) NR technology as specified by 3GPP (3^{rd} Generation Partnership Project), it is known to use multi-antenna techniques and beamforming. Utilization of beamforming can help to significantly increase data rates and/or reliability of wireless communication. In some cases, both the transmitter and the receiver are equipped with multiple antennas, so that wireless transmissions can be performed on a multiple-input multiple-output (MIMO) communication channel. Corresponding MIMO functionalities are for example supported in the 5G NR technology.

In the NR technology, UL (uplink) beamforming, i.e., beamforming of UL wireless transmissions from a UE (User Equipment) to the wireless communication network can for example be implemented by configuring an SRS (Sounding Reference Signal) transmission by the UE. The SRS can then be received by an access node of the wireless communication network, in the 5G NR technology denoted as “gNB” and be used to estimate the radio channel between the UE and the gNB. Based on the estimation of the radio channel, the gNB derives beamforming parameters to be used by the UE in a beamformed PUSCH (Physical UL Shared Channel) transmission to the gNB. The gNB then configures the UE to perform the PUSCH by sending DCI (Downlink Control Information) to the UE. The DCI contain information about how to perform the PUSCH transmission, including the derived beamforming parameters. For example the DCI could indicate a TPMI (Transmitted Precoding Matrix Indicator), a TRI (Transmission Rank Indicator), and an SRI (SRS Resource Indicator). Using a codebook specified by the NR standard, see for example 3GPP TS 38.214 V16.7.0 (2021-09), these parameters control how the UE performs beamforming of the PUSCH transmission. Corresponding procedures are also defined for beamforming of PUCCH (Physical UL Control Channel) transmissions and SRS transmissions.

Further, the NR technology also supports non codebook-based UL beamforming. In this case, the gNB sends a DL (downlink) wireless transmission with CSI-RSs (Channel State Information Reference Signals) to the UE when configuring the SRS transmission. The CSI-RSs enable the UE to determine a set of precoders based on assuming channel reciprocity. The set of precoders in turn defines a set of SRS ports which are used by the UE when sending the SRS.

DL beamforming in the NR technology can be performed on the basis of feedback from the UE. In this case, the gNB configures the UE to receive CSI-RSs from the gNB. The CSI-RSs enable the UE to estimate the radio channel between the gNB and the UE. From the received CSI-RSs the UE derives beamforming parameters to be used by the gNB in a beamformed PDSCH (Physical DL Shared Channel) transmission to the UE. The UE sends a message containing CSI (channel state information) to the gNB and this message also indicates the beamforming parameters, e.g., PMI (Precoding Matrix Indicator), RI (Rank Indicator) and CQI (Channel Quality Indicator). Corresponding procedures are also defined for beamforming of PDCCH (Physical DL Control Channel) transmissions.

As can be seen, the existing beamforming procedures rely on exchange of information between the gNB and the UE in both UL and DL directions. For this reason, the existing procedures are not suited for scenarios where the gNB or similar access node is limited with respect to its capability to transmit in DL. Such types of access nodes are for example considered as a way of meeting further increased demand on capacity and user throughput in wireless communication networks, where the UL capacity may become a limiting factor. This can be attributed to a natural imbalance of spectral efficiency between UL and DL, e.g., due to the number of antennas in access nodes and available transmit power levels typically being higher than in UEs. Further, it is also expected that there could be an increase of UL heavy services like gaming, V2V (Vehicle to Vehicle) communication, or the like. Accordingly, by providing access nodes which operate only in the UL, herein also referred to as UL-only nodes, the focus of densification of the wireless communication networks can be shifted to the UL. As compared to regular access nodes which operate in both the UL and the DL, the benefit of UL-only nodes include lower complexity, lower weight, smaller volume, lower complexity of deployment, and avoidance of permits to deploy radio transmitters.

Accordingly, there is a need for techniques which allow for efficiently controlling beamforming in scenarios involving one or more UL-only nodes or other access nodes with limited DL capability.

### SUMMARY

According to an embodiment, a method of controlling wireless communication is provided. According to the method, an access node of a wireless communication network controls a wireless device to perform a first UL wireless transmission receivable by a further access node of the wireless communication network. Further, the access node receives, from the further access node, beamforming feedback related to the first UL wireless transmission. Based on the received beamforming feedback, the access node controls beamforming of a second UL wireless transmission from the wireless device to the further access node.

According to a further embodiment, a method of controlling wireless communication is provided. According to the method, an access node of a wireless communication network receives a first UL wireless transmission from a wireless device. Further, the access node determines beamforming feedback related to the first UL wireless transmission. Further, the access node sends the beamforming feedback to a further access node of the wireless communication network. The beamforming feedback enables the further access node to control beamforming of a second UL wireless transmission from the wireless device to the access node.

According to a further embodiment, a method of controlling wireless communication is provided. According to the method, a wireless device performs a first UL wireless transmission receivable by an access node of the wireless communication network. In response to the first UL wireless transmission, the wireless device receives at least one beamforming parameter from a further access node of the wireless communication network. Based on the received at least one beamforming parameter, the wireless device performs a beamformed second UL wireless transmission to the access node.

According to a further embodiment, a method of controlling wireless communication is provided. According to the method, an access node of a wireless communication network performs a first DL wireless transmission to a wireless device. In response to the first DL wireless transmission, the access node receives beamforming feedback related to the first DL wireless transmission from a further access node of the wireless communication network. Based on the received beamforming feedback, the access node performs a beamformed second DL wireless transmission to the wireless device.

According to a further embodiment, a method of controlling wireless communication is provided. According to the method, an access node of a wireless communication network receives a UL wireless transmission from a wireless device. The UL wireless transmission indicates at least one channel estimate measured by the wireless device on a first DL wireless transmission from a further access node of the wireless communication network. Based on the received UL wireless transmission, the access node sends beamforming feedback related to the first DL wireless transmission to the further access node. The beamforming feedback enables the further access node to perform a beamformed second DL wireless transmission to the wireless device.

According to a further embodiment, a method of controlling wireless communication is provided. According to the method, a wireless device receives a first DL wireless transmission from an access node of the wireless communication network. Further, the wireless device sends a UL wireless transmission to a further access node of the wireless communication network. The UL wireless transmission indicates at least one channel estimate measured by the wireless device on the first DL wireless transmission. The further access node is configured to send beamforming feedback to the access node, the beamforming feedback relating to the first DL wireless transmission and enabling the access node to perform a beamformed second DL wireless transmission to the wireless device.

According to a further embodiment, an access node for a wireless communication network is provided. The access node is configured to control a wireless device to perform a first UL wireless transmission receivable by a further access node of the wireless communication network. Further, the access node is configured to receive, from the further access node, beamforming feedback related to the first UL wireless transmission Further, the access node is configured to, based on the received beamforming feedback, control beamforming of a second UL wireless transmission from the wireless device to the further access node.

According to a further embodiment, an access node for a wireless communication network is provided. The access node comprises at least one processor and a memory. The memory contains instructions executable by said at least one processor, whereby the access node is operative to control a wireless device to perform a first UL wireless transmission receivable by a further access node of the wireless communication network. Further, the memory contains instructions executable by said at least one processor, whereby the access node is operative to receive, from the further access node, beamforming feedback related to the first UL wireless transmission Further, the memory contains instructions executable by said at least one processor, whereby the access node is operative to, based on the received beamforming feedback, control beamforming of a second UL wireless transmission from the wireless device to the further access node.

According to a further embodiment, an access node for a wireless communication network is provided. The access node is configured to receive a first UL wireless transmission from a wireless device. Further, the access node is configured to determine beamforming feedback related to the first UL wireless transmission. Further, the access node is configured to send the beamforming feedback to a further access node of the wireless communication network. The beamforming feedback enables the further access node to control beamforming of a second UL wireless transmission from the wireless device to the access node.

According to a further embodiment, an access node for a wireless communication network is provided. The access node comprises at least one processor and a memory. The memory contains instructions executable by said at least one processor, whereby the access node is operative to receive a first UL wireless transmission from a wireless device. Further, the memory contains instructions executable by said at least one processor, whereby the access node is operative to determine beamforming feedback related to the first UL wireless transmission. Further, the memory contains instructions executable by said at least one processor, whereby the access node is operative to send the beamforming feedback to a further access node of the wireless communication network. The beamforming feedback enables the further access node to control beamforming of a second UL wireless transmission from the wireless device to the access node.

According to a further embodiment, a wireless device for operation in a wireless communication network is provided. The wireless device is configured to perform a first UL wireless transmission to an access node of the wireless communication network. Further, the access node is configured to, in response to the first UL wireless transmission, receive at least one beamforming parameter from a further access node of the wireless communication network. Further, the access node is configured to, based on the received at least one beamforming parameter, perform a beamformed second UL wireless transmission to the access node.

According to a further embodiment, a wireless device for operation in a wireless communication network is provided. The wireless device comprises at least one processor and a memory. The memory contains instructions executable by said at least one processor, whereby the wireless device is operative to perform a first UL wireless transmission to an access node of the wireless communication network. Further, the memory contains instructions executable by said at least one processor, whereby the wireless device is operative to, in response to the first UL wireless transmission, receive at least one beamforming parameter from a further access node of the wireless communication network.

Further, the memory contains instructions executable by said at least one processor, whereby the wireless device is operative to, based on the received at least one beamforming parameter, perform a beamformed second UL wireless transmission to the access node.

According to a further embodiment, an access node for a wireless communication network is provided. The access node is configured to perform a first DL wireless transmission to a wireless device. Further, the access node is configured to, in response to the first DL wireless transmission, receive beamforming feedback related to the first DL wireless transmission from a further access node of the wireless communication network. Further, the access node is configured to, based on the received beamforming feedback, perform a beamformed second DL wireless transmission to the wireless device.

According to a further embodiment, an access node for a wireless communication network is provided. The access node comprises at least one processor and a memory. The memory contains instructions executable by said at least one processor, whereby the access node is operative to perform a first DL wireless transmission to a wireless device. Further, the memory contains instructions executable by said at least one processor, whereby the access node is operative to, in response to the first DL wireless transmission, receive beamforming feedback related to the first DL wireless transmission from a further access node of the wireless communication network. Further, the memory contains instructions executable by said at least one processor, whereby the access node is operative to, based on the received beamforming feedback, perform a beamformed second DL wireless transmission to the wireless device.

According to a further embodiment, an access node for a wireless communication network is provided. The access node is configured to receive a UL wireless transmission from a wireless device. The UL wireless transmission indicates at least one channel estimate measured by the wireless device on a first DL wireless transmission from a further access node of the wireless communication network. Further, the access node is configured to, based on the received UL wireless transmission, send beamforming feedback related to the first DL wireless transmission to the further access node. The beamforming feedback enables the further access node to perform a beamformed second DL wireless transmission to the wireless device.

According to a further embodiment, an access node for a wireless communication network is provided. The access node comprises at least one processor and a memory. The memory contains instructions executable by said at least one processor, whereby the access node is operative to receive a UL wireless transmission from a wireless device. The UL wireless transmission indicates at least one channel estimate measured by the wireless device on a first DL wireless transmission from a further access node of the wireless communication network. Further, the memory contains instructions executable by said at least one processor, whereby the access node is operative to, based on the received UL wireless transmission, send beamforming feedback related to the first DL wireless transmission to the further access node. The beamforming feedback enables the further access node to perform a beamformed second DL wireless transmission to the wireless device.

According to a further embodiment, a wireless device for operation in a wireless communication network is provided. The wireless device is configured to receive a first DL wireless transmission from an access node of the wireless communication network. Further, the wireless device is configured to send a UL wireless transmission to a further access node of the wireless communication network. The UL wireless transmission indicates at least one channel estimate measured by the wireless device on the first DL wireless transmission, and the further access node is configured to send beamforming feedback to the access node. The beamforming feedback relates to the first DL wireless transmission and enables the access node to perform a beamformed second DL wireless transmission to the wireless device.

According to a further embodiment, a wireless device for operation in a wireless communication network is provided. The wireless device comprises at least one processor and a memory. The memory contains instructions executable by said at least one processor, whereby the wireless device is operative to receive a first DL wireless transmission from an access node of the wireless communication network. Further, the memory contains instructions executable by said at least one processor, whereby the wireless device is operative to send a UL wireless transmission to a further access node of the wireless communication network. The UL wireless transmission indicates at least one channel estimate measured by the wireless device on the first DL wireless transmission, and the further access node is configured to send beamforming feedback to the access node. The beamforming feedback relates to the first DL wireless transmission and enables the access node to perform a beamformed second DL wireless transmission to the wireless device.

According to a further embodiment of the invention, a computer program or computer program product is provided, e.g., in the form of a non-transitory storage medium, which comprises program code to be executed by at least one processor of an access node for a wireless communication network. Execution of the program code causes the access node to control a wireless device to perform a first UL wireless transmission receivable by a further access node of the wireless communication network. Further, execution of the program code causes the access node to receive, from the further access node, beamforming feedback related to the first UL wireless transmission Further, execution of the program code causes the access node to, based on the received beamforming feedback, control beamforming of a second UL wireless transmission from the wireless device to the further access node.

According to a further embodiment of the invention, a computer program or computer program product is provided, e.g., in the form of a non-transitory storage medium, which comprises program code to be executed by at least one processor of an access node for a wireless communication network. Execution of the program code causes the access node to receive a first UL wireless transmission from a wireless device. Further, execution of the program code causes the access node to determine beamforming feedback related to the first UL wireless transmission. Further, execution of the program code causes the access node to send the beamforming feedback to a further access node of the wireless communication network. The beamforming feedback enables the further access node to control beamforming of a second UL wireless transmission from the wireless device to the access node.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to perform a first UL wireless transmission to an access node of the wireless communication network. Further, execution of the program code causes the wireless device to, in response to the first UL wireless transmission, receive at least one beamforming parameter from a further access node of the wireless communication network. Further, execution of the program code causes the wireless device to, based on the received at least one beamforming parameter, perform a beamformed second UL wireless transmission to the access node.

According to a further embodiment of the invention, a computer program or computer program product is provided, e.g., in the form of a non-transitory storage medium, which comprises program code to be executed by at least one processor of an access node for a wireless communication network. Execution of the program code causes the access node to perform a first DL wireless transmission to a wireless device. Further, execution of the program code causes the access node to, in response to the first DL wireless transmission, receive beamforming feedback related to the first DL wireless transmission from a further access node of the wireless communication network. Further, execution of the program code causes the access node to, based on the received beamforming feedback, perform a beamformed second DL wireless transmission to the wireless device.

According to a further embodiment of the invention, a computer program or computer program product is provided, e.g., in the form of a non-transitory storage medium, which comprises program code to be executed by at least one processor of an access node for a wireless communication network. Execution of the program code causes the access node to receive a UL wireless transmission from a wireless device. The UL wireless transmission indicates at least one channel estimate measured by the wireless device on a first DL wireless transmission from a further access node of the wireless communication network. Further, execution of the program code causes the access node to, based on the received UL wireless transmission, send beamforming feedback related to the first DL wireless transmission to the further access node. The beamforming feedback enables the further access node to perform a beamformed second DL wireless transmission to the wireless device.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to receive a first DL wireless transmission from an access node of the wireless communication network. Further, execution of the program code causes the wireless device to send a UL wireless transmission to a further access node of the wireless communication network. The UL wireless transmission indicates at least one channel estimate measured by the wireless device on the first DL wireless transmission, and the further access node is configured to send beamforming feedback to the access node. The beamforming feedback relates to the first DL wireless transmission and enables the access node to perform a beamformed second DL wireless transmission to the wireless device.

Details of such embodiments and further embodiments will be apparent from the following detailed description of embodiments.

### BRIEF DESCRIPTION OF THE DRAWINGS

FIG. 1 schematically illustrates a wireless communication network according to an embodiment.

FIG. 2A schematically illustrates an example of a scenario involving beamforming of UL wireless transmissions to an access node having limited DL capability, according to an embodiment.

FIG. 2B schematically illustrates a further example of a scenario involving beamforming of UL wireless transmissions to an access node having limited DL capability, according to an embodiment.

FIG. 2C schematically illustrates a further example of a scenario involving beamforming of UL wireless transmissions to an access node having limited DL capability, according to an embodiment.

FIG. 3A schematically illustrates an example of a scenario involving beamforming of DL wireless transmissions with assistance of an access node having limited DL capability, according to an embodiment.

FIG. 3B schematically illustrates a further example of a scenario involving beamforming of DL wireless transmissions with assistance of an access node having limited DL capability, according to an embodiment.

FIG. 3C schematically illustrates a further example of a scenario involving beamforming of DL wireless transmissions with assistance of multiple access nodes having limited DL capability, according to an embodiment.

FIG. 4 shows a flowchart for schematically illustrating a method according to an embodiment.

FIG. 5 shows an exemplary block diagram for illustrating functionalities of an access node implementing functionalities corresponding to the method of FIG. 4.

FIG. 6 shows a flowchart for schematically illustrating a further method according to an embodiment.

FIG. 7 shows an exemplary block diagram for illustrating functionalities of an access node implementing functionalities corresponding to the method of FIG. 6.

FIG. 8 shows a flowchart for schematically illustrating a further method according to an embodiment.

FIG. 9 shows an exemplary block diagram for illustrating functionalities of a wireless device implementing functionalities corresponding to the method of FIG. 8.

FIG. 10 shows a flowchart for schematically illustrating a further method according to an embodiment.

FIG. 11 shows an exemplary block diagram for illustrating functionalities of an access node implementing functionalities corresponding to the method of FIG. 10.

FIG. 12 shows a flowchart for schematically illustrating a further method according to an embodiment.

FIG. 13 shows an exemplary block diagram for illustrating functionalities of an access node implementing functionalities corresponding to the method of FIG. 12.

FIG. 14 shows a flowchart for schematically illustrating a further method according to an embodiment.

FIG. 15 shows an exemplary block diagram for illustrating functionalities of a wireless device implementing functionalities corresponding to the method of FIG. 14.

FIG. 16 schematically illustrates structures of an access node according to an embodiment.

FIG. 17 schematically illustrates structures of a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless communication between a wireless communication network and a wireless device (WD). The wireless communication network may be based on the 5G NR technology specified by 3GPP. However, other technologies could be used as well, e.g., the 4G LTE technology specified by 3GPP or a future 6G (6^{th} Generation) technology. The WD may correspond to various types of UEs or other types of WDs. As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VoIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

In the illustrated concepts, an UL only node or access node which otherwise is limited with respect to its capability of performing DL wireless transmissions cooperates with another access node to enable beamformed UL wireless transmissions from a UE to the access node and/or to assist the other access node in performing beamformed DL wireless transmissions to a UE. This may involve that the other access node sends one or more DL wireless transmissions which are received by the UE. The beamforming may then be based on these one or more DL wireless transmissions. For example, such DL wireless transmission could include a reference signal to be used for channel estimation by the UE. Further, such DL wireless transmission could include beamforming control information. In addition or as an alternative, this may involve that the access node receives one or more UL wireless transmissions from the UE. For example, such UL wireless transmission could include a reference signal to be used for channel estimation by the access node. Further, such UL wireless transmission could include beamforming control information.

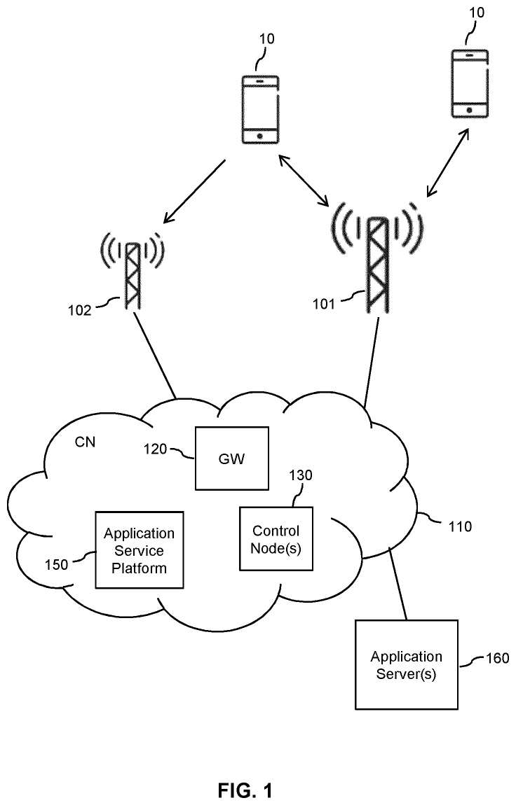

FIG. 1 illustrates exemplary structures of the wireless communication network. In particular, FIG. 1 shows UEs 10 which are served by access nodes 101, 102 of the wireless communication network. The access nodes 101, 102 may be located at different geographical locations. Here, it is noted that each access node 101, 102 may participate in serving a number of cells within the coverage area of the wireless communication network. In the following, it is assumed that the access nodes 101, 102 are based on the NR technology and each correspond to a gNB or implement at least a part of the functionalities of a gNB. The access nodes 101, 102 may each be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may be used for controlling the user data traffic, e.g., by providing control data to the access node 100, the GW 120, and/or to the UE 10. Such control data may in particular have the purpose of configuring the above-mentioned utilization of the early acknowledgement message.

As illustrated by double-headed arrows, the access node 101 may send DL wireless transmissions to the UEs 10, and the UEs may send UL wireless transmissions to the access node 101. The access node 102 is however assumed to be an UL only node and capable of receiving UL wireless transmissions from the UEs 10, as illustrated by a single headed arrow, but not capable of sending DL wireless transmissions. In alternative scenarios, the access node 102 could be otherwise limited with respect to its DL capability, e.g., by being limited to send only certain types of DL wireless transmissions and/or by being limited to send DL wireless transmission with a limited transmit power which is significantly lower than the transmit power available to a regular access node like the access node 101. In a scenario like illustrated in FIG. 1, one of the UEs 10 could for example send its UL wireless transmissions to the access node 102 and receive its DL wireless transmissions from the access node 101.

The DL transmissions and UL transmissions may be used to provide various kinds of services to the UEs 10, e.g., a voice service, a multimedia service, or a data service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user data traffic conveyed by the DL transmissions and/or the UL transmissions between the access node(s) 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the UP traffic between the UE 10 and the access node 100.

In the illustrated concepts, the access node 102, which is an UL only node or otherwise is limited with respect to its capability of performing DL transmissions, may cooperate with the access node 101 to enable beamformed UL transmissions to the access node 102 and/or to assist the access node 101 in performing beamformed DL transmissions.

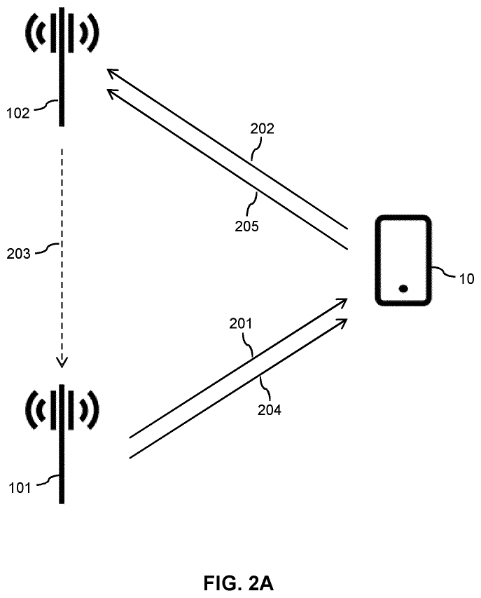

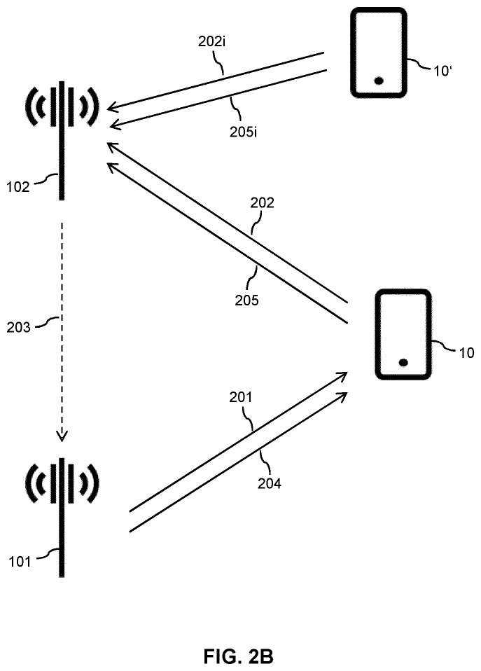

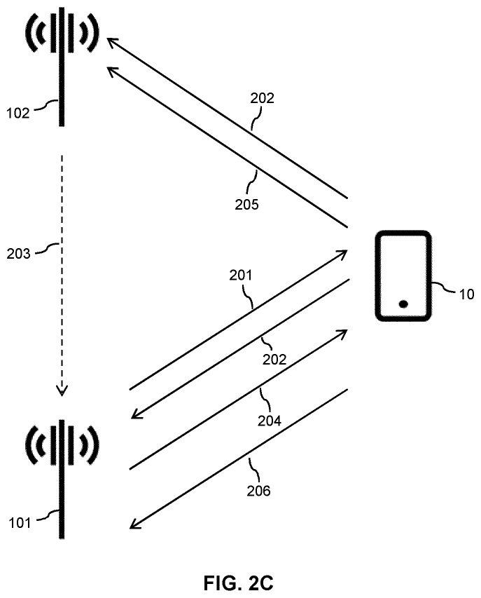

FIG. 2A illustrates a first exemplary scenario, where the access node 102 cooperates with the access node 101 to enable one or more beamformed UL wireless transmissions from a UE 10 to the access node 102. This involves that the access node 101 sends a DL wireless transmission 201 to the UE 10, to configure the UE 10 to perform a UL wireless transmission 202. Here, it is noted that configuring the UE 10 to perform the UL wireless transmission 202 may include instructing the UE 10 to perform the UL wireless transmission 202 or otherwise triggering the UL wireless transmission 202. In some cases, configuring the UE 10 to perform the UL wireless transmission 202 may also include providing the UE 10 with further information for controlling how the UE 10 shall perform the UL wireless transmission 202, e.g., by indicating resources to be used for the UL wireless transmission 202. The UL wireless transmission 202 may be an SRS transmission. Alternatively or in addition, the UL wireless transmissions could also be or include a transmission of DMRS (Demodulation Reference Signal), PUSCH, PUCCH, and/or PRACH (Physical Random Access Channel). The DL wireless transmission 201 may for example convey RRC (Radio Resource Control) signaling, DCI (Downlink Control Information), and/or a MAC CE (Medium Access Control Control Element) to configure the UE 10 to perform the UL wireless transmission 202. For example, a MAC CE can be used to configure the UL wireless transmission 202 as part of semi-persistent reference signal transmissions or DCI can be used to configure the UL wireless transmission 202 as an aperiodic reference signal transmission.

If the UL wireless transmission 202 includes an SRS transmission, the SRS transmission can for example be based on an SRS resource set for UL codebook based transmission. In this case, a parameter ‘usage’ in SRS-Config information element (IE) as specified in 3GPP TS 38.331 V16.6.0 (2021-09) would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’. In accordance with the configuration provided by the DL wireless transmission 201, the UE 10 then sends the SRS transmission 202 or other UL wireless transmission.

The access node 102 receives the UL wireless transmission 202 and performs measurements on the received UL wireless transmission 202 to estimate the channel between the access node 102 and the UE 10. As indicated by signaling 203, the access node 102 may then communicate information derived from the measurements to the access node 101. This information may for example include an encoded version of the received UL wireless transmission and/or information indicating how the UE 10 should perform a further UL wireless transmission to the access node 102. Assuming that the further UL wireless transmission is a PUSCH transmission using codebook based precoding, the information may for example include a TPMI, a TRI, an SRI, a CQI, an MCS, a Joint TCI state ID, and/or a UL TCI state ID. The signaling 203 can for example be conveyed via a backhaul interface between the access nodes 101, 102. The information may in particular indicate how the UE 10 should perform beamforming of the further UL wireless transmission, e.g. in terms of TCI state ID, SRI, TPMI and/or TRI.

The access node 101 then sends a further DL wireless transmission 204 to the UE 10. The further DL wireless transmission 204 includes control data indicating how the UE 10 should perform the further UL wireless transmission to the access node 102, e.g., in DCI, a MAC CE, and/or RRC signaling. This control data is based on the information indicated by the signaling from the access node 102. The control information may for example indicate a TPMI, a TRI, an SRI, an MCS, a Joint TCI state ID, and/or a UL TCI state ID. In some scenarios, at least some of these parameters indicated in the control data can already be determined by the access node 102 and be indicated in the information conveyed by the signaling 203. However, at least some of the parameters indicated in the control data could also be derived by the access node 101, using the information conveyed by the signaling 203 as input. Based on the indicated control data, the UE 10 then performs the beamformed further UL wireless transmission, as indicated by 205. The beamformed further UL wireless transmission 205 can be a PUSCH transmission, a PUCCH transmission, or an SRS transmission. The beamforming of the further UL wireless transmission 205 is controlled based on the control data indicated by the further DL wireless transmission 204.

FIG. 2B illustrates a scenario which is similar to that of FIG. 2A, but with an additional UE 10′ being present and transmitting concurrently with the UL wireless transmission 202 and/or the further UL wireless transmission 205. FIG. 2B illustrates UL wireless transmission 202i as an example of such additional interfering UL wireless transmission.

In the scenario of FIG. 2B, the access node 101 sends a DL wireless transmission 201 to the UE 10, to configure the UE 10 to perform a UL wireless transmission 202. The UL wireless transmission 202 may be an SRS transmission. Alternatively or in addition, the UL wireless transmissions could also be or include a transmission of DMRS, PUSCH, PUCCH, and/or PRACH. The DL wireless transmission 201 may for example convey RRC signaling, a MAC CE, and/or DCI to configure the UE 10 to perform the UL wireless transmission 202. For example, RRC signaling can be used to configure the UL wireless transmission 202 as part of periodic reference signal transmissions, a MAC CE can be used to configure the UL wireless transmission 202 as part of semi-persistent reference signal transmissions or DCI can be used to configure the UL wireless transmission 202 as an aperiodic reference signal transmission.

If the UL wireless transmission 202 includes an SRS transmission, the SRS transmission can for example be based on an SRS resource set for UL codebook based transmission. In this case, a parameter ‘usage’ in SRS-Config IE would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’. In accordance with the configuration provided by the DL wireless transmission 201, the UE 10 then sends the SRS transmission 202 or other UL wireless transmission.

In a similar manner, the access node 101 or some other access node may configure the additional UE 10′ to perform the interfering UL wireless transmission 202i. The interfering UL wireless transmission 202i may include an SRS transmission, a DMRS transmission, and/or a PUSCH transmission. When performing the measurements on the received UL wireless transmission 202 to estimate the channel between the access node 102 and the UE 10, the access node 102 may take into account an interference contribution from the interfering UL wireless transmission 202i from the additional UE 10′, and the beamforming may be adapted accordingly.

The access node 102 receives the UL wireless transmission 202 and performs measurements on the received UL wireless transmission 202 to estimate the channel between the access node 102 and the UE 10. As indicated by signaling 203, the access node 102 may then communicate information derived from the measurements to the access node 101. This information may for example include an encoded version of the received UL wireless transmission and/or information indicating how the UE 10 should perform a further UL wireless transmission to the access node 102. Assuming that the further UL wireless transmission is a PUSCH transmission using codebook based precoding, the information may for example include a TPMI, a TRI, an SRI, a CQI, an MCS, a Joint TCI state ID, and/or a UL TCI state ID. The signaling 203 can for example be conveyed via a backhaul, midhaul and/or fronthaul interface between the access nodes 101, 102. The information may in particular indicate how the UE 10 should perform beamforming of the further UL wireless transmission, e.g. in terms of TCI state ID, SRI, TPMI and/or RI, also taking into account the interference from the additional UE 10′.

The access node 101 then sends a further DL wireless transmission 204 to the UE 10. The further DL wireless transmission 204 includes control data indicating how the UE 10 should perform the further UL wireless transmission to the access node 102, e.g., in DCI, a MAC CE, and/or RRC signaling. This control data is based on the information indicated by the signaling from the access node 102. The control information may for example indicate a TPMI, a TRI, an SRI, an MCS, a Joint TCI state ID, and/or a UL TCI state ID. In some scenarios, at least some of these parameters indicated in the control data can already be determined by the access node 102 and be indicated in the information conveyed by the signaling 203. However, at least some of the parameters indicated in the control data could also be derived by the access node 101, using the information conveyed by the signaling 203 as input. Based on the indicated control data, the UE 10 then performs the beamformed further UL wireless transmission, as indicated by 205. The beamformed further UL wireless transmission 205 can be a PUSCH transmission, a PUCCH transmission, or an SRS transmission. The beamforming of the further UL wireless transmission 205 is controlled based on the control data indicated by the further DL wireless transmission 204 and thus takes into account the estimated channel between the access node 102 and the UE 10 and also the interference from the additional UE 10′, e.g., as generated by a concurrent UL wireless transmission 205i performed by the additional UE 10′.

It is noted that the consideration of interference from an additional UE 10′ as explained in connection with the scenario of FIG. 2B could also be applied in a corresponding manner to scenarios where multiple additional UEs 10 are considered as sources of interference.

FIG. 2C illustrates a scenario which is similar to that of FIG. 2A, but with the UE 10 utilizing macro-diversity by having the possibility to send an UL wireless transmissions 206 to the access node 101.

In the scenario of FIG. 2C, the access node 101 sends a DL wireless transmission 201 to the UE 10, to configure the UE 10 to perform a UL wireless transmission 202. The UL wireless transmission 202 may be an SRS transmission. Alternatively or in addition, the UL wireless transmissions could also be or include a transmission of DMRS, PUSCH, PUCCH, and/or PRACH. The DL wireless transmission 201 may for example convey RRC signaling, a MAC CE, and/or DCI to configure the UE 10 to perform the UL wireless transmission 202. For example, RRC signaling can be used to configure the UL wireless transmission 202 as part of periodic reference signal transmissions, a MAC CE can be used to configure the UL wireless transmission 202 as part of semi-persistent reference signal transmissions or DCI can be used to configure the UL wireless transmission 202 as an aperiodic reference signal transmission.

If the UL wireless transmission 202 includes an SRS transmission, the SRS transmission can for example be based on an SRS resource set for UL codebook based transmission. In this case, a parameter ‘usage’ in SRS-Config IE would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’. In accordance with the configuration provided by the DL wireless transmission 201, the UE 10 then sends the SRS transmission 202 or other UL wireless transmission.

The access node 102 receives the UL wireless transmission 202 and performs measurements on the received UL wireless transmission 202 to estimate the channel between the access node 102 and the UE 10. As indicated by signaling 203, the access node 102 may then communicate information derived from the measurements to the access node 101. This information may for example include an encoded version of the received UL wireless transmission and/or information indicating how the UE 10 should perform a further UL wireless transmission to the access node 102. Assuming that the further UL wireless transmission is a PUSCH transmission using codebook based precoding, the information may for example include a TPMI, a TRI, an SRI, a CQI, an MCS, a Joint TCI state ID, and/or a UL TCI state ID. The signaling 203 can for example be conveyed via a backhaul, midhaul, and/or fronthaul interface between the access nodes 101, 102. The information may in particular indicate how the UE 10 should perform beamforming of the further UL wireless transmission, e.g. in terms of TCI state ID, SRI, TPMI and/or TRI.

In the scenario of FIG. 2C, the UL wireless transmission 202 is also received by the access node 101. Similar to the access node 102, the access node 101 performs measurements on the received UL wireless transmission 202, to estimate the channel between the access 101 and the UE 10. Based on the measurements, the access node 101 determines further information which indicates how the UE 10 should perform a beamformed UL wireless transmission to the access node 101. The further information may for example include a TPMI, a TRI, an SRI, a CQI, an MCS, a Joint TCI state ID, and/or a UL TCI state ID. Based on the further information, it can for example be decided in a dynamic manner whether the UE 10 should perform a beamformed UL wireless transmission 205 to the access node 102 or a beamformed UL wireless transmission 206 to the access node 102, e.g., by comparing a performance metric related to the information determined by the access node 101 to a performance metric related to the information determined by the access node 101. In other scenarios, it would also be possible to perform both the beamformed UL wireless transmission 205 and the beamformed UL wireless transmission 206.

The access node 101 then sends a further DL wireless transmission 204 to the UE 10. The further DL wireless transmission 204 includes control data indicating how the UE 10 should perform the beamformed UL wireless transmission 205 to the access node 102 and/or the beamformed UL wireless transmission 206 to the access node 101, e.g., in DCI, a MAC CE, and/or RRC signaling. This control data is based on the information indicated by the signaling from the access node 102. The control information may for example indicate a TPMI, a TRI, an SRI, an MCS, a Joint TCI state ID, and/or a UL TCI state ID for the respective UL wireless transmission 205, 206. The beamformed UL wireless transmission 205, 206 can be a PUSCH transmission, a PUCCH transmission, or an SRS transmission. The beamforming of the UL wireless transmission 205, 206 is controlled based on the control data indicated by the further DL wireless transmission 204.

The principles of controlling UL beamforming may vary with respect to the content of the signaling 203 from the access node 102 to the access node 101:

In some variants, the information conveyed by the signaling 203 may include a beam, precoder, beam index, or precoder index. Such beam index could for example be one or a combination of SRS resource set index, SRI, Joint TCI state ID and UL TCI state ID. For such beam index, the information may optionally also include a corresponding UL performance metric, e.g., in terms of RSRP (Reference Signal Received Power), UL SINR, and/or UL SNR.

In some variants, the information conveyed by the signaling 203 may include a set of beams, precoders, a set of beam indexes, or a set of precoder indexes, with or without a corresponding set of weights.

In some variants the access node 102 may condition the information indicated in the signaling as follows: To a set of input data in the information derived from the measurements on the UL wireless transmission 202, the access node 101 may apply at least one linear transformation which reduces the dimension of the set of input data. To each scalar value of the output of the at least one linear transformation, the access node 102 then applies a nonlinear transformation. Then the access node 102 quantizes each output from the nonlinear transformation. This quantization is performed independently of the other scalar values. The quantized output is the conveyed by the signaling 203 to the access node 101.

In some variants, the information conveyed by the signaling 203 may include information about the phase difference between antennas of the UE 10, a channel estimate, and/or a covariance matrix of the channel estimate.

The information conveyed by the signaling 203 may relate to the full UL bandwidth available to the UE 10 or to only a subset of the UL bandwidth available to the UE 10. The information may be indicated in a wideband manner, i.e., for the entire considered UL bandwidth, or in a subband manner, i.e., individually for each of multiple subbands within the entire considered UL bandwidth.

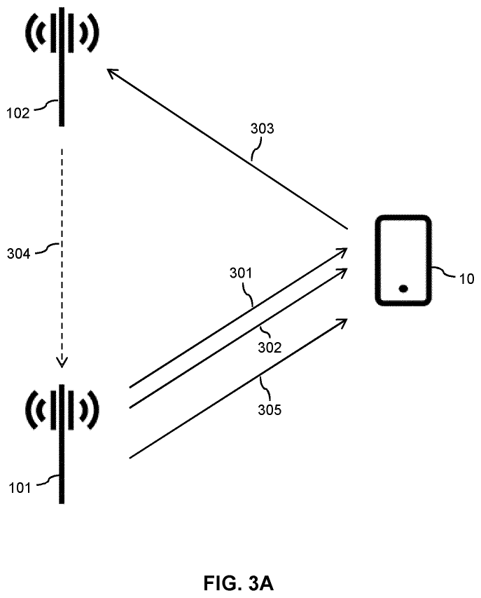

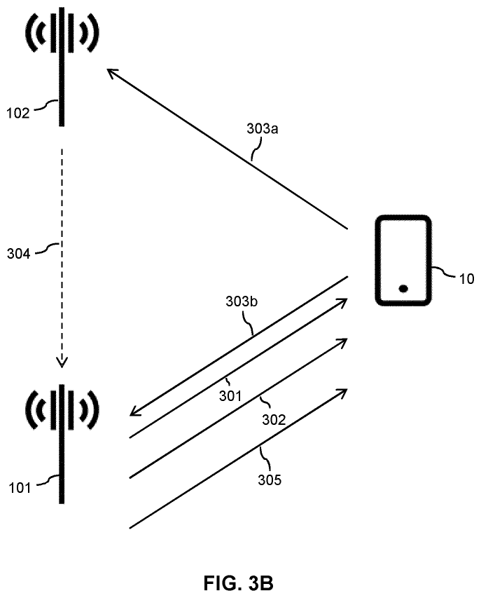

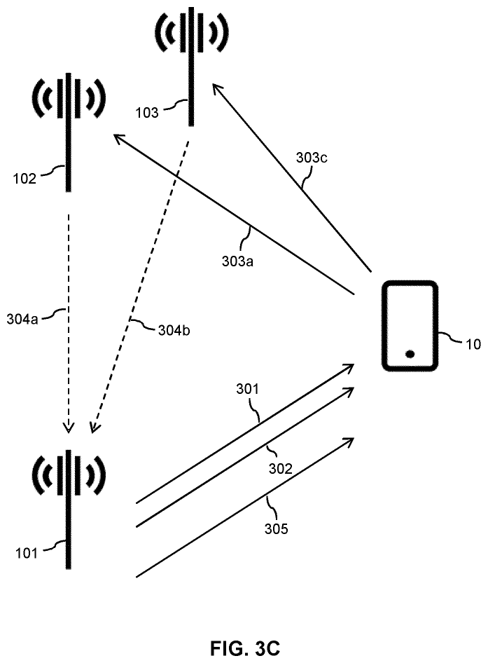

FIG. 3A illustrates a first exemplary scenario, where the access node 102 cooperates with the access node 101 to assist in performing one or more beamformed DL wireless transmissions from the access node 101 to a UE 10. This involves that the access node 101 sends a DL wireless transmission 301 to the UE 10, to configure the UE 10 to receive a further DL wireless transmission 302 including a reference signal. The reference signal may include CSI-RS or an SSB. The DL wireless transmission 301 may for example include RRC signaling, a MAC CE, and/or DCI to configure the UE 10 to receive CSI-RS. For example, RRC signaling can be used to indicate periodic CSI-RS, a MAC CE can be used to indicate semi-persistent CSI-RS or DCI can be used to indicate aperiodic CSI-RS.

The UE 10 receives the DL wireless transmission 302 including the reference signal and performs measurements on the received DL wireless transmission 302 to estimate the channel between the access node 101 and the UE 10. These measurements are used to derive information that can be that used for controlling a beamformed DL wireless transmission from the access node 101 to the UE 10. For example, the information derived by the UE 10 may include CSI related properties like, e.g., RSRP, SINR, CSI-RS resource index, SSB index, PMI, RI and/or CQI.

The UE 10 then sends a UL wireless transmission 303 indicating the derived information to the access node 102. The UL wireless transmission 303 can for example be a PUCCH transmission or a PUSCH transmission. In some scenarios, the UL wireless transmission 303 may additionally also include an SRS transmission configured by the DL wireless transmission 301. The SRS transmission can for example be based on an SRS resource set for UL codebook based transmission. In this case, a parameter ‘usage’ in the SRS-Config information IE would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’.

The access node 102 receives the UL wireless transmission 303 and may use the indicated information to derive information how the access node 101 should perform the beamformed DL wireless transmission to the UE. For this purpose, the access node 102 may also perform measurements on the received UL wireless transmission 303 to estimate the channel between the access node 102 and the UE 10. Based on the estimation, the access node 102 may then derive the information how the access node 101 should perform the beamformed DL wireless transmission to the UE. As indicated by signaling 304, the access node 102 may then communicate information derived from the measurements to the access node 101. Further, the access node 102 also receives the information derived by the UE 10 and indicated by the DL wireless transmission 303. The information indicated by signaling 304 may for example include an encoded version of the received UL wireless transmission 303. In addition or as an alternative, the information indicated by signaling 304 may indicate other information relating to how the access node 101 should perform the beamformed DL wireless transmission to the UE 10, e.g., PMI, RI, RSRP, SINR, CSI-RS resource index, SSB index, and/or CQI as determined by the UE 10 from the measurements on the DL wireless transmission 302.

The access node 101 then sends the beamformed DL wireless transmission 305 to the UE 10. The beamformed DL wireless transmission 305, in particular the beamforming, is controlled based on the information indicated by the signaling 304. However, it is noted that the access node 101 could also consider other inputs in controlling the beamformed UL wireless transmission, e.g., measurements performed by the access node 101 itself.

FIG. 3B illustrates a scenario which is similar to that of FIG. 3A, but with the UE 10 utilizing macro-diversity by having the possibility to send an UL wireless transmission 303b to the access node 101.

In the scenario of FIG. 3B, the access node 101 sends a DL wireless transmission 301 to the UE 10, to configure the UE 10 to receive a further DL wireless transmission 302 including a reference signal. The reference signal may include CSI-RS. The DL wireless transmission 301 may for example include RRC signaling, a MAC CE, and/or DCI to configure the UE 10 to receive CSI-RS. For example, RRC signaling can be used to indicate periodic CSI-RS, a MAC CE can be used to indicate semi-persistent CSI-RS or DCI can be used to indicate aperiodic CSI-RS.

The UE 10 receives the DL wireless transmission 302 including the reference signal and performs measurements on the received DL wireless transmission 302 to estimate the channel between the access node 101 and the UE 10. These measurements are used to derive information that can be that used for controlling a beamformed DL wireless transmission from the access node 101 to the UE 10. For example, the information derived by the UE 10 may include CSI related properties like, e.g., RSRP, SINR, CSI-RS resource index, SSB index, PMI, RI and/or CQI.

The UE 10 then sends a UL wireless transmission 303a indicating the derived information to the access node 102. The UL wireless transmission 303a can for example be a PUCCH transmission or a PUSCH transmission. In some scenarios, the UL wireless transmission 303a may additionally also include an SRS transmission configured by the DL wireless transmission 301. The SRS transmission can for example be based on an SRS resource set for UL codebook based transmission. In this case, a parameter ‘usage’ in the SRS-Config information IE would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’.

The access node 102 receives the UL wireless transmission 303a and may use the indicated information to derive information how the access node 101 should perform the beamformed DL wireless transmission to the UE. For this purpose, the access node 102 may also perform measurements on the received UL wireless transmission 303, or the SRS transmission from the UE 10, to estimate the channel between the access node 102 and the UE 10. Based on the estimation, the access node 102 may then derive the information how the access node 101 should perform the beamformed DL wireless transmission to the UE. As indicated by signaling 304, the access node 102 may then communicate information derived from the measurements to the access node 101. Further, the access node 102 also receives the information derived by the UE 10 and indicated by the DL wireless transmission 303. The information indicated by signaling 304 may for example include an encoded version of the received UL wireless transmission 303. In addition or as an alternative, the information indicated by signaling 304 may indicate other information relating to how the access node 101 should perform the beamformed DL wireless transmission to the UE 10, e.g., PMI, RI, RSRP, SINR, CSI-RS resource index, SSB index, and/or CQI as determined by the UE 10 from the measurements on the DL wireless transmission 302.

In the scenario of FIG. 3B, the UE 10 also sends a UL wireless transmission 303b indicating the information derived by the UE 10 to the access node 101. The UL wireless transmission 303b can for example be a PUCCH transmission or a PUSCH transmission. Based on the information indicated by the UL wireless transmission 303b, the access node 101 can derive further information relating to how the access node 101 should perform the beamformed DL wireless transmission to the UE 10. This further information may then be used to supplement or, in some cases, replace the information indicated by signaling 304.

The access node 101 then sends the beamformed DL wireless transmission 305 to the UE 10. The beamformed DL wireless transmission 305, in particular the beamforming, is controlled based on the information indicated by the signaling 304. However, it is noted that the access node 101 could also consider other inputs in controlling the beamformed UL wireless transmission, e.g., measurements performed by the access node 101 itself.

FIG. 3C illustrates a scenario which is similar to that of FIG. 3A, but assuming that there are multiple access nodes 102, 103 with limited DL capability, which support the access node 101 in performing a beamformed DL wireless transmission to the UE 10.

In the scenario of FIG. 3C, the access node 101 sends a DL wireless transmission 301 to the UE 10, to configure the UE 10 to receive a further DL wireless transmission 302 including a reference signal. The reference signal may include CSI-RS. The DL wireless transmission 301 may for example include RRC signaling, a MAC CE, and/or DCI to configure the UE 10 to received CSI-RS. For example, RRC signaling can be used to indicate periodic CSI-RS, a MAC CE can be used to indicate semi-persistent CSI-RS or DCI can be used to indicate aperiodic CSI-RS.

The UE 10 receives the DL wireless transmission 302 including the reference signal and performs measurements on the received DL wireless transmission 302 to estimate the channel between the access node 101 and the UE 10. These measurements are used to derive information that can be that used for controlling a beamformed DL wireless transmission from the access node 101 to the UE 10. For example, the information derived by the UE 10 may include CSI related properties like, e.g., RSRP, SINR, CSI-RS resource index, SSB index, PMI, RI and/or CQI.

The UE 10 then sends a UL wireless transmission 303a indicating the derived information to the access node 102. The UL wireless transmission 303a can for example be a PUCCH transmission or a PUSCH transmission. In some scenarios, the UL wireless transmission 303a may additionally also include an SRS transmission configured by the DL wireless transmission 301. The SRS transmission can for example be based on an SRS resource set for UL codebook based transmission. In this case, a parameter ‘usage’ in the SRS-Config information IE would be set to ‘codebook’. Alternatively, the SRS transmission could be based on an SRS resource set for UL non-codebook based transmission. In this case, the parameter ‘usage’ in the SRS-Config IE would be set to ‘nonCodebook’. Alternatively, the SRS transmission could be based on an SRS resource set for UL beam management. In this case, the parameter ‘usage’ in the SRS-Config IE would be set to ‘beamManagement’.

Further, the UE 10 then sends a UL wireless transmission 303c indicating the derived information to the access node 103. The UL wireless transmission 303c can for example be a PUCCH transmission or a PUSCH transmission.

The access node 102 receives the UL wireless transmission 303a and may use the indicated information to derive information how the access node 101 should perform the beamformed DL wireless transmission to the UE. For this purpose, the access node 102 may also perform measurements on the received UL wireless transmission 303a, or the SRS transmission from the UE 10, to estimate the channel between the access node 102 and the UE 10. Based on the estimation, the access node 102 may then derive the information how the access node 101 should perform the beamformed DL wireless transmission to the UE. As indicated by signaling 304a, the access node 102 may then communicate information derived from the measurements to the access node 101. Further, the access node 102 also receives the information derived by the UE 10 and indicated by the DL wireless transmission 303a. The information indicated by signaling 304a may for example include an encoded version of the received UL wireless transmission 303a. In addition or as an alternative, the information indicated by signaling 304a may indicate other information relating to how the access node 101 should perform the beamformed DL wireless transmission to the UE 10, e.g., PMI, RI, RSRP, SINR, CSI-RS resource index, SSB index, and/or CQI as determined by the UE 10 from the measurements on the DL wireless transmission 302.

Similarly, the access node 103 receives the UL wireless transmission 303c and may use the indicated information to derive information how the access node 101 should perform the beamformed DL wireless transmission to the UE. For this purpose, the access node 103 may also perform measurements on the received UL wireless transmission 303c, or the SRS transmission from the UE 10, to estimate the channel between the access node 103 and the UE 10. The access node 103 may then apply a channel reciprocity assumption to derive the information how the access node 101 should perform the beamformed DL wireless transmission to the UE. As indicated by signaling 304b, the access node 102 may then communicate information derived from the measurements to the access node 101. Further, the access node 103 also receives the information derived by the UE 10 and indicated by the DL wireless transmission 303c. The information indicated by signaling 304c may for example include an encoded version of the received UL wireless transmission 303c. In addition or as an alternative, the information indicated bv signaling 304c may indicate other information relating to how the access node 101 should perform the beamformed DL wireless transmission to the UE 10, e.g., PMI, RI, RSRP, SINR, CSI-RS resource index, SSB index, and/or CQI as determined by the UE 10 from the measurements on the DL wireless transmission 302.

The access node 101 then sends the beamformed DL wireless transmission 305 to the UE 10. The beamformed DL wireless transmission 305, in particular the beamforming, is controlled based on the information indicated by the signaling 304a and 304c. However, it is noted that the access node 101 could also consider other inputs in controlling the beamformed UL wireless transmission, e.g., measurements performed by the access node 101 itself or information indicated directly from UE 10, e.g., like in the example of FIG. 3B.

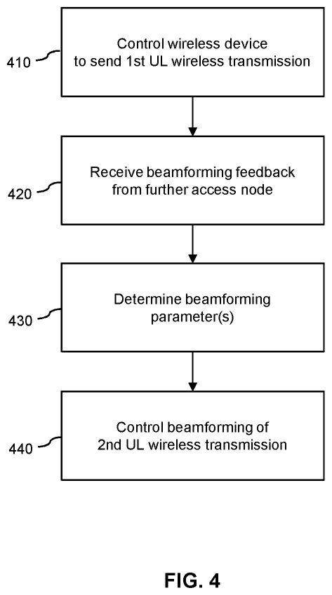

FIG. 4 shows a flowchart for illustrating a method, which may be utilized for implementing the illustrated concepts. The method of FIG. 4 may be used for implementing the illustrated concepts in an access node of a wireless communication network. For example, the access node may correspond to the above-mentioned access node 101.

If a processor-based implementation of the access node is used, at least some of the steps of the method of FIG. 4 may be performed and/or controlled by one or more processors of the access node. Such node may also include a memory storing program code for implementing at least some of the below described functionalities or steps of the method of FIG. 4.

At step 410, the access node controls a wireless device to perform a first UL wireless transmission receivable by a further access node of the wireless communication network. The wireless device may be a UE, such as one of the above-mentioned UEs 10. The further access node may be an access node which is limited with respect to its capability of sending DL wireless transmissions to the wireless device. For example, the further access node could be not capable of sending any DL wireless transmissions due to hardware design. In other cases, the further access node could be provided with only a basic capability to send DL wireless transmissions, e.g., due to hardware limitations. In some case, DL operation of the further access node could also limited by configuration. The above-mentioned access nodes 102, 103 are examples of such DL limited access nodes. The UL wireless transmission 202 in the examples of FIGS. 2A, 2B, and 2C is an example of the first UL wireless transmission controlled at step 410.

Step 410 may for example involve sending control signaling to the wireless device to configure the wireless device to perform a first UL wireless transmission, e.g., RRC signaling, a MAC CE, and/or DCI. The first UL wireless transmission may include at least one SRS.

At step 420, the access node receives beamforming feedback from the further access node, as explained for signaling 203 of FIGS. 2A, 2B, and 2C. The beamforming feedback is related to the first UL wireless transmission. The beamforming feedback may indicate at least one beamforming parameter to be applied by the wireless device in sending a second UL wireless transmission. The at least one beamforming parameter may include a TCI State identifier, a TPMI, an SRI, and/or a TRI. In addition or as an alternative, the beamforming feedback may include at least one channel estimate which is based on the first UL wireless transmission. In addition or as an alternative, the beamforming feedback may include a signal representation of the first UL wireless transmission. The information conveyed by the signaling 203 of FIGS. 2A, 2B, and 2C is an example of such beamforming feedback.

At step 430, the access node may determine at least one beamforming parameter to be applied by the wireless device in sending a second UL wireless transmission. The access node may determine the at least one beamforming parameter based on the beamforming feedback received at step 420. For example, if the beamforming feedback includes at least one channel estimate which is based on the first UL wireless transmission, the access node may determine the at least one beamforming parameter based on the at least one channel estimate. Further, if the beamforming feedback includes a signal representation of the first UL wireless transmission, the access node may determine the at least one beamforming parameter based on the signal representation of the first UL wireless transmission. The at least one beamforming parameter determined at step 430 may include a TCI State identifier, a TPMI, an SRI, and/or a TRI. In some scenarios, the beamforming feedback may further be based on interference of a third UL wireless transmission to the first UL wireless transmission, such as the interfering UL wireless transmission in the example of FIG. 2B.

At step 440, the access node controls beamforming of a second UL wireless transmission from the wireless device to the further access node. The control of the beamforming at step 440 is based on the beamforming feedback received at step 420. For example, the control of the beamforming at step 440 can be based on the beamforming parameters directly indicated by the beamforming feedback of step 420 and/or the beamforming parameters derived from the beamforming feedback at step 430. Step 440 may involve that the access node sends control data including the at least one beamforming parameter to the wireless device. The control data may for example include DCI, a MAC CE and/or RRC signaling. The beamformed UL wireless transmission 205 in the examples of FIGS. 2A, 2B, and 2C is an example of the second UL wireless transmission controlled at step 440.

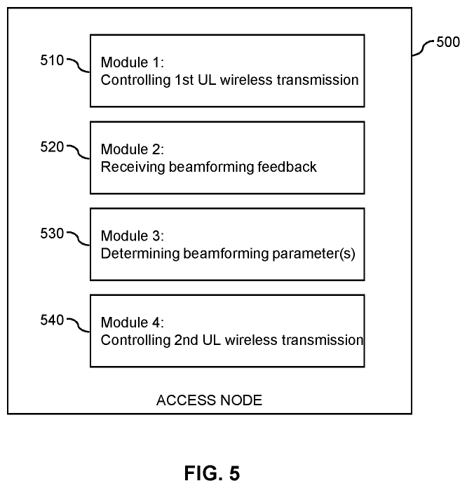

FIG. 5 shows a block diagram for illustrating functionalities of an access node 500 for a wireless communication network which operates according to the method of FIG. 4. The access node 500 may for example correspond to above-mentioned access node 101. As illustrated, the access node 500 may be provided with a module 510 configured to control a first UL wireless transmission, such as explained in connection with step 410. Further, the access node 500 may be provided with a module 520 configured to receive beamforming feedback, such as explained in connection with step 420. Further, the access node 500 may be provided with a module 430 configured to determine at least one beamforming parameter, such as explained in connection with step 430. Further, the access node 500 may be provided with a module 540 configured to control beamforming of a second UL wireless transmission, such as explained in connection with step 440.

It is noted that the access node 500 may include further modules for implementing other functionalities, such as known functionalities of a gNB in the NR technology or of an eNB in the LTE technology. Further, it is noted that the modules of the access node 500 do not necessarily represent a hardware structure of the access node 500, but may also correspond to functional elements, e.g., implemented by hardware, software, or a combination thereof.

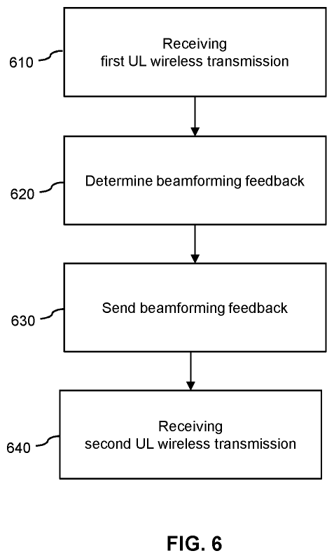

FIG. 6 shows a flowchart for illustrating a method, which may be utilized for implementing the illustrated concepts. The method of FIG. 6 may be used for implementing the illustrated concepts in an access node of a wireless communication network. The further access node may be an access node which is limited with respect to its capability of sending DL wireless transmissions to the wireless device. For example, the further access node could be not capable of sending any DL wireless transmissions due to hardware design. In other cases, the further access node could be provided with only a basic capability to send DL wireless transmissions, e.g., due to hardware limitations. In some case, DL operation of the further access node could also limited by configuration. For example, the access node may correspond to any of the above-mentioned access nodes 102, 103.

If a processor-based implementation of the access node is used, at least some of the steps of the method of FIG. 6 may be performed and/or controlled by one or more processors of the access node. Such node may also include a memory storing program code for implementing at least some of the below described functionalities or steps of the method of FIG. 6.

At step 610, the access node receives a first UL wireless transmission a wireless device. The wireless device may be a UE, such as one of the above-mentioned UEs 10. The UL wireless transmission 202 in the examples of FIGS. 2A, 2B, and 2C is an example of the first UL wireless transmission controlled at step 610. The first UL wireless transmission may include at least one SRS.

At step 620, the access node determines beamforming feedback for controlling beamforming of a second UL wireless transmission from the wireless device to a further access node of the wireless communication network. The beamforming feedback is related to the first UL wireless transmission. The beamforming feedback may indicate at least one beamforming parameter to be applied by the wireless device in sending the second UL wireless transmission. The at least one beamforming parameter may include a TCI State identifier, a TPMI, an SRI, and/or a TRI. In addition or as an alternative, the beamforming feedback may include at least one channel estimate which is based on the first UL wireless transmission. In addition or as an alternative, the beamforming feedback may include a signal representation of the first UL wireless transmission. The information conveyed by the signaling 203 of FIGS. 2A, 2B, and 2C is an example of such beamforming feedback.

In some scenarios, the access node may determine the beamforming feedback further based on interference of a third UL wireless transmission to the first UL wireless transmission. The third UL wireless transmission may for example be received at step 610, along with the first UL wireless transmission.

At step 630, the access node sends the beamforming feedback to the further access node. This may for example involve sending control signaling, as explained for signaling 203 of FIGS. 2A, 2B, and 2C. The beamforming feedback enables the further access node to control beamforming of a second UL wireless transmission from the wireless device to the access node.

At step 640, the access node may receive the second UL wireless transmission from the wireless device, with the beamforming of the second UL wireless transmission being controlled based on the beamforming feedback sent at step 630.

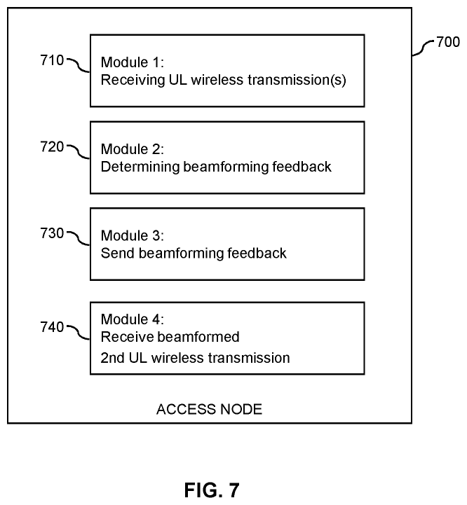

FIG. 7 shows a block diagram for illustrating functionalities of an access node 700 for a wireless communication network which operates according to the method of FIG. 6. The access node 700 may for example correspond to any of the above-mentioned access nodes 102, 103. As illustrated, the access node 700 may be provided with a module 610 configured to receive a first UL wireless transmission, such as explained in connection with step 610. Further, the access node 700 may be provided with a module 720 configured to determine beamforming feedback, such as explained in connection with step 620. Further, the access node 700 may be provided with a module 730 configured to send the beamforming feedback to a further access node, such as explained in connection with step 630. Further, the access node 700 may be provided with a module 740 configured to receive a second UL wireless transmission, such as explained in connection with step 640.

It is noted that the access node 700 may include further modules for implementing other functionalities, such as known functionalities of a gNB in the NR technology or of an eNB in the LTE technology. Further, it is noted that the modules of the access node 700 do not necessarily represent a hardware structure of the access node 700, but may also correspond to functional elements, e.g., implemented by hardware, software, or a combination thereof.

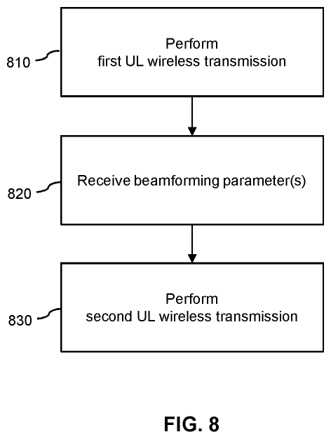

FIG. 8 shows a flowchart for illustrating a method, which may be utilized for implementing the illustrated concepts. The method of FIG. 8 may be used for implementing the illustrated concepts in a wireless device operating in a wireless communication network. For example, the access node may correspond to a UE, such as one of the above-mentioned UE 10.

If a processor-based implementation of the wireless device is used, at least some of the steps of the method of FIG. 8 may be performed and/or controlled by one or more processors of the wireless device. Such wireless device may also include a memory storing program code for implementing at least some of the below described functionalities or steps of the method of FIG. 8.

At step 810, the wireless device performs a first UL wireless transmission which is receivable by an access node of the wireless communication network. The wireless device may be a UE, such as one of the above-mentioned UEs 10. The access node may be an access node which is limited with respect to its capability of sending DL wireless transmissions to the wireless device. For example, the access node could be not capable of sending any DL wireless transmissions due to hardware design. In other cases, the further access node could be provided with only a basic capability to send DL wireless transmissions, e.g., due to hardware limitations. In some case, DL operation of the access node could also limited by configuration. The above-mentioned access nodes 102, 103 are examples of such DL limited access nodes. The UL wireless transmission 202 in the examples of FIGS. 2A, 2B, and 2C is an example of the first UL wireless transmission performed at step 810. The first UL wireless transmission may include at least one SRS.

Step 810 may for example involve that the wireless device receives control signaling from a further access node of the wireless communication network, which control signaling configures the wireless device to perform the first UL wireless transmission, e.g., RRC signaling, a MAC CE, and/or DCI.

At step 820, in response to sending the first UL wireless transmission of step 810, the wireless device receives at least one beamforming parameter from the further access node The at least one beamforming parameter is based on measurements performed on the first UL wireless transmission. The at least one beamforming parameter may include a TCI State identifier, a TPMI, an SRI, and/or a TRI. In addition or as an alternative, the beamforming feedback may include at least one channel estimate which is based on the first UL wireless transmission. The wireless device may receive the at least one beamforming parameter in control data provided by the further access node. The control data may for example include DCI, a MAC CE and/or RRC signaling.

At step 830, the wireless device performs a second UL wireless transmission. The second UL wireless transmission is beamformed with the aim of optimizing reception at the access node. For example, control of the beamforming is based on the at least one beamforming parameter received at step 820. The beamformed UL wireless transmission 205 in the examples of FIGS. 2A, 2B, and 2C is an example of the second UL wireless transmission performed at step 830.

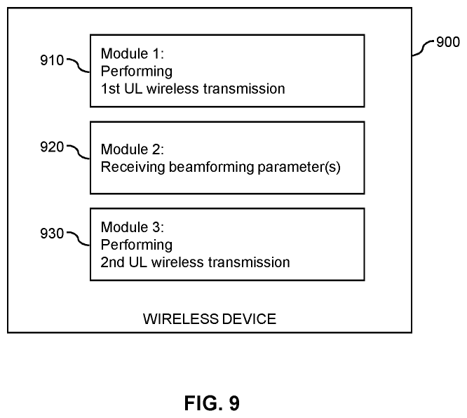

FIG. 9 shows a block diagram for illustrating functionalities of a wireless device 900 which operates according to the method of FIG. 8. The wireless device 900 may for example correspond to a UE, e.g., one of the above-mentioned UEs 10. As illustrated, the wireless device 900 may be provided with a module 910 configured to perform a first UL wireless transmission, such as explained in connection with step 810. Further, the wireless device 900 may be provided with a module 920 configured to receive at least one beamforming parameter, such as explained in connection with step 820. Further, the wireless device 900 may be provided with a module 930 configured to performed a beamformed second UL wireless transmission, such as explained in connection with step 830.

It is noted that the methods of FIGS. 4, and 6, and optionally claim 8, may also be combined in a system which includes a first access node operating according to the method of FIG. 4 and a second access node operating according to the method of FIG. 6. Optionally, such system may also include a wireless device operating according to the method of FIG. 8. In such system, the first access node would control the wireless device to perform the first UL wireless transmission. The second access node would receive the first UL wireless transmission, based thereon determine the beamforming feedback, and provide the beamforming feedback to the first access node. Based on the beamforming feedback, the first access node would then provide the at least one beamforming parameter to the wireless device, to thereby control the beamforming of the second UL wireless transmission from the wireless device to the second access node.

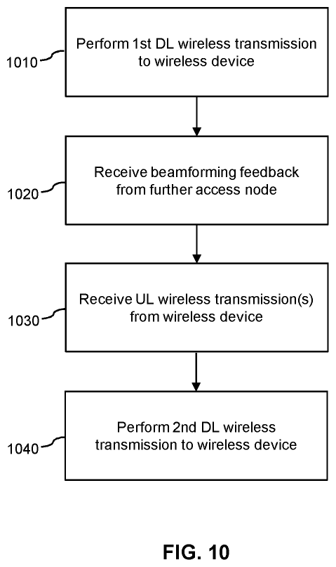

FIG. 10 shows a flowchart for illustrating a method, which may be utilized for implementing the illustrated concepts. The method of FIG. 10 may be used for implementing the illustrated concepts in an access node of a wireless communication network. For example, the access node may correspond to the above-mentioned access node 101.

If a processor-based implementation of the access node is used, at least some of the steps of the method of FIG. 10 may be performed and/or controlled by one or more processors of the access node. Such node may also include a memory storing program code for implementing at least some of the below described functionalities or steps of the method of FIG. 10.

At step 1010, the access node performs a first DL wireless transmission to a wireless device. The wireless device may correspond to a UE, e.g., one of the above-mentioned UEs 10. The DL wireless transmission 301 in the examples of FIGS. 3A, 3B, and 3C is an example of the first DL wireless transmission performed at step 1010. The first DL wireless transmission may include at least one CSI-RS, and/or at least one Synchronization Signal Block, SSB.

At step 1020, in response to the first DL wireless transmission of step 1010, the access node receives beamforming feedback related to the first DL wireless transmission. The access node receives the beamforming feedback from a further access node of the wireless communication network. The further access node may be an access node which is limited with respect to its capability of sending DL wireless transmissions to the wireless device. For example, the further access node could be not capable of sending any DL wireless transmissions due to hardware design. In other cases, the further access node could be provided with only a basic capability to send DL wireless transmissions, e.g., due to hardware limitations. In some case, DL operation of the further access node could also limited by configuration. The above-mentioned access nodes 102, 103 are examples of such DL limited access nodes. The signaling 304, 304a, and 304b in the examples of FIGS. 3A, 3B, and 3C is an example of conveying such beamforming feedback from the further access node to the access node.

The beamforming feedback may include at least one channel estimate measured by the wireless device on the first DL wireless transmission. The at least one channel estimate may indicate a PMI, an RI, a CQI, and/or at least beam performance metric. Alternatively or in addition, the beamforming feedback may include information measured on an UL wireless transmission indicating the at least one channel estimate to the further access node. The UL wireless transmissions 303, 303a, and 303c in the examples of FIGS. 3A, 3B, and 3C are examples of such UL wireless transmission. Alternatively or in addition, the beamforming feedback may include a signal representation of such UL wireless transmission indicating the at least one channel estimate to the further access node.

In some scenarios, the access node may receive such beamforming feedback related to the first DL wireless transmission from multiple further access nodes, e.g., as explained in connection with the example of FIG. 3C.

At step 1030, the access node may receive at least one UL wireless transmission from the wireless device. The at least one UL wireless transmission received at step 1030 may be the UL wireless transmission indicating the at least one channel estimate to the further access node. Further, the at least one UL wireless transmission received at step 1030 may include an SRS transmission

At step 1040, the access node performs a beamformed second DL wireless transmission to the wireless device. The access node performs the beamformed second DL wireless transmission based on the beamforming feedback received at step 1020. In some scenarios, the access node may perform the beamformed second DL wireless transmission also based on the at least one UL wireless transmission received at step 1030

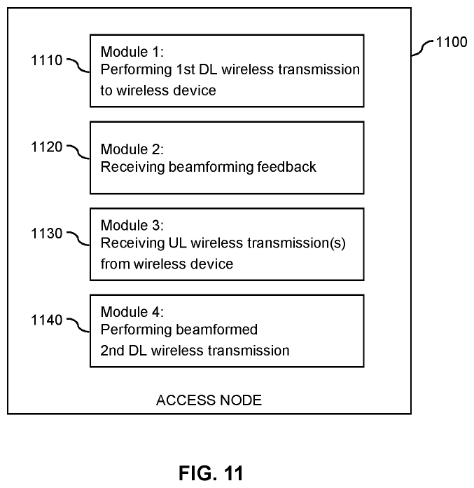

FIG. 11 shows a block diagram for illustrating functionalities of an access node 1100 for a wireless communication network which operates according to the method of FIG. 10. The access node 1100 may for example correspond to above-mentioned access node 101. As illustrated, the access node 1100 may be provided with a module 1110 configured to perform a first DL wireless transmission, such as explained in connection with step 1010. Further, the access node 1100 may be provided with a module 1120 configured to receive beamforming feedback, such as explained in connection with step 1020. Further, the access node 1100 may be provided with a module 1130 configured to receive at least one UL wireless transmission, such as explained in connection with step 1030. Further, the access node 1100 may be provided with a module 1140 configured to control beamforming of a second DL wireless transmission, such as explained in connection with step 1040.

It is noted that the access node 1100 may include further modules for implementing other functionalities, such as known functionalities of a gNB in the NR technology or of an eNB in the LTE technology. Further, it is noted that the modules of the access node 1100 do not necessarily represent a hardware structure of the access node 1100, but may also correspond to functional elements, e.g., implemented by hardware, software, or a combination thereof.

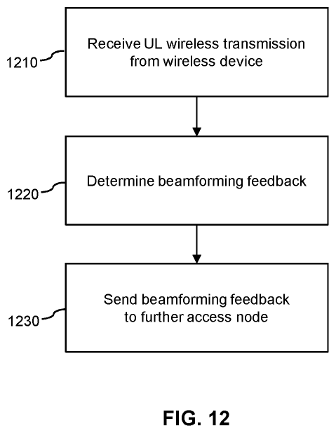

FIG. 12 shows a flowchart for illustrating a method, which may be utilized for implementing the illustrated concepts. The method of FIG. 12 may be used for implementing the illustrated concepts in an access node of a wireless communication network. The access node may be an access node which is limited with respect to its capability of sending DL wireless transmissions to the wireless device. For example, the access node could be not capable of sending any DL wireless transmissions due to hardware design. In other cases, the access node could be provided with only a basic capability to send DL wireless transmissions, e.g., due to hardware limitations. In some case, DL operation of the access node could also limited by configuration. The above-mentioned access nodes 102, 103 are examples of such DL limited access nodes.

If a processor-based implementation of the access node is used, at least some of the steps of the method of FIG. 10 may be performed and/or controlled by one or more processors of the access node. Such node may also include a memory storing program code for implementing at least some of the below described functionalities or steps of the method of FIG. 12.

At step 1210, the access node receives a UL wireless transmission from a wireless device. The wireless device may correspond to a UE, e.g., one of the above-mentioned UEs 10. The UL wireless transmission indicates at least one channel estimate measured by the wireless device on a first DL wireless transmission from a further access node of the wireless communication network. The DL wireless transmission 301 in the examples of FIGS. 3A, 3B, and 3C is an example of such first DL wireless transmission. The first DL wireless transmission may include at least one CSI-RS, and/or at least one Synchronization Signal Block, SSB. The further access node may for example correspond to the above-mentioned access node 101. The UL wireless transmissions 303, 303a, and 303c in the examples of FIGS. 3A, 3B, and 3C are examples of the UL wireless transmission received at step 1210.

At step 1220, based on the received UL wireless transmission, the access node determines beamforming feedback related to the first DL wireless transmission.

At step 1230, the access node sends the beamforming feedback to the further access node. The beamforming feedback enables the further access node to perform a beamformed second DL wireless transmission to the wireless device. The signaling 304, 304a, and 304b in the examples of FIGS. 3A, 3B, and 3C is an example of conveying such beamforming feedback from the access node to the further access node.

The beamforming feedback may include at least one channel estimate measured by the wireless device on the first DL wireless transmission. The at least one channel estimate may indicate a PMI, an RI, a CQI, and/or at least beam performance metric. Alternatively or in addition, the beamforming feedback may include information measured on the UL wireless transmission received at step 1210. Alternatively or in addition, the beamforming feedback may include a signal representation of the UL wireless transmission received at step 1210.

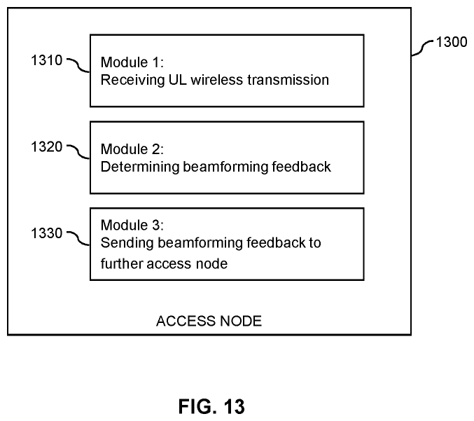

FIG. 13 shows a block diagram for illustrating functionalities of an access node 1300 for a wireless communication network which operates according to the method of FIG. 13. The access node 1300 may for example correspond to one of the above-mentioned access nodes 102, 103. As illustrated, the access node 1300 may be provided with a module 1310 configured to receive a UL wireless transmission, such as explained in connection with step 1210. Further, the access node 1300 may be provided with a module 1320 configured to determine beamforming feedback, such as explained in connection with step 1320. Further, the access node 1300 may be provided with a module 1330 configured to send the beamforming feedback to a further access node, such as explained in connection with step 1230.

It is noted that the access node 1300 may include further modules for implementing other functionalities, such as known functionalities of a gNB in the NR technology or of an eNB in the LTE technology. Further, it is noted that the modules of the access node 1300 do not necessarily represent a hardware structure of the access node 1300, but may also correspond to functional elements, e.g., implemented by hardware, software, or a combination thereof.

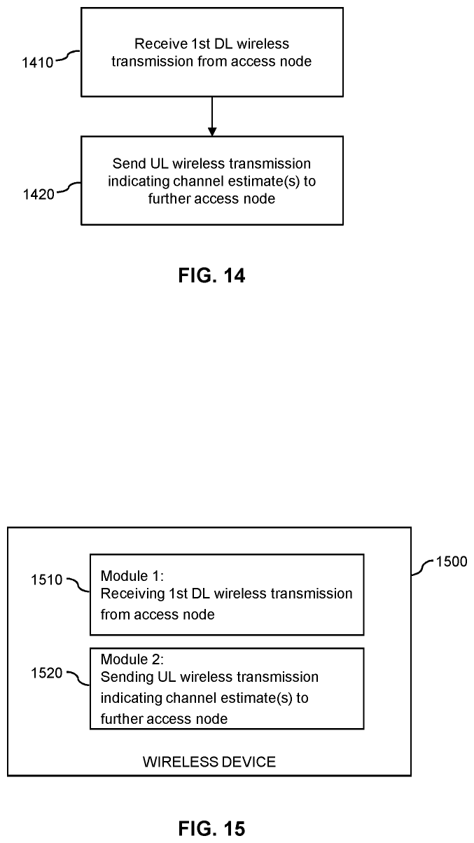

FIG. 14 shows a flowchart for illustrating a method, which may be utilized for implementing the illustrated concepts. The method of FIG. 14 may be used for implementing the illustrated concepts in a wireless device operating in a wireless communication network. For example, the access node may correspond to a UE, such as one of the above-mentioned UE 10.

If a processor-based implementation of the wireless device is used, at least some of the steps of the method of FIG. 14 may be performed and/or controlled by one or more processors of the wireless device. Such wireless device may also include a memory storing program code for implementing at least some of the below described functionalities or steps of the method of FIG. 14.

At step 1410, the wireless device receives a first DL wireless transmission from an access node of the wireless communication network. The access node may correspond to the above-mentioned access node 101. The DL wireless transmission 301 in the examples of FIGS. 3A, 3B, and 3C is an example of the first DL wireless transmission performed at step 1010. The first DL wireless transmission may include at least one CSI-RS, and/or at least one Synchronization Signal Block, SSB.

At step 1420; the wireless device sends a UL wireless transmission to a further access node of the wireless communication network. The UL wireless transmission indicates at least one channel estimate measured by the wireless device on the first DL wireless transmission. The further access node is configured to send beamforming feedback to the access node. This beamforming feedback relates to the first DL wireless transmission and enables the access node to perform a beamformed second DL wireless transmission to the wireless device. The further access node may be an access node which is limited with respect to its capability of sending DL wireless transmissions to the wireless device. For example, the further access node could be not capable of sending any DL wireless transmissions due to hardware design. In other cases, the further access node could be provided with only a basic capability to send DL wireless transmissions, e.g., due to hardware limitations. In some case, DL operation of the further access node could also limited by configuration. The above-mentioned access nodes 102, 103 are examples of such DL limited access nodes.

The at least one channel estimate may indicate a PMI, an RI, a CQI, and/or at least beam performance metric. The UL wireless transmissions 303, 303a, and 303c in the examples of FIGS. 3A, 3B, and 3C are examples of the UL wireless transmission sent at step 1420.

FIG. 15 shows a block diagram for illustrating functionalities of a wireless device 1500 which operates according to the method of FIG. 14. The wireless device 1500 may for example correspond to a UE, e.g., one of the above-mentioned UEs 10. As illustrated, the wireless device 1500 may be provided with a module 1510 configured to receive a first DL wireless transmission, such as explained in connection with step 1410. Further, the wireless device 1500 may be provided with a module 1520 configured to send a UL wireless transmission, such as explained in connection with step 1420.

It is noted that the methods of FIGS. 10, and 12, and optionally claim 14, may also be combined in a system which includes a first access node operating according to the method of FIG. 10 and a second access node operating according to the method of FIG. 12. Optionally, such system may also include a wireless device operating according to the method of FIG. 14. In such system, the first access node would send the first DL wireless transmission to the wireless device. The second access node would receive the first UL wireless transmission indicating the channel estimate(s) from the wireless device and, based thereon, determine the beamforming feedback, and provide the beamforming feedback to the first access node. Based on the beamforming feedback, the first access node would then perform the second DL wireless transmission to the wireless device.

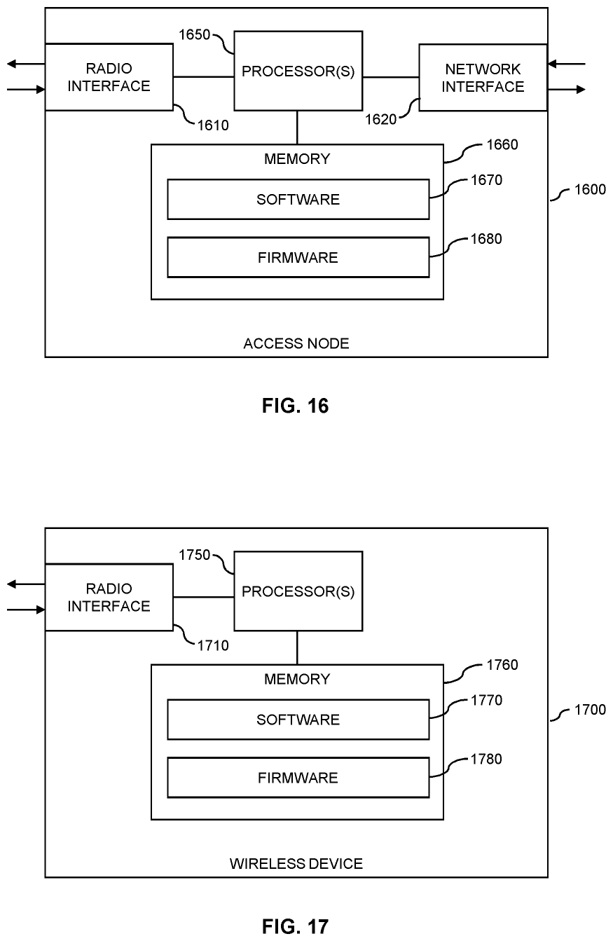

FIG. 16 illustrates a processor-based implementation of an access node 1600 for a wireless communication network, which may be used for implementing the above-described concepts.

For example, the structures as illustrated in FIG. 16 may be used for implementing the concepts in the access node 101, 102, or 103.

As illustrated, the access node 1600 may include one or more radio interfaces 1610. The radio interface(s) 1610 may for example be based on the NR technology or the LTE technology. The radio interface(s) 1610 may be used for connecting to wireless devices, such as any of the above-mentioned UEs 10. Further, the node 1600 may include one or more network interfaces 1620. The network interface(s) 1620 may for example be used for communication with one or more other nodes of the wireless communication network, e.g., other access nodes.

Further, the access node 1600 may include one or more processors 1650 coupled to the interface(s) 1610, 1620 and a memory 1660 coupled to the processor(s) 1650. By way of example, the interface(s) 1610, 1620, the processor(s) 1650, and the memory 1660 could be coupled by one or more internal bus systems of the node 1600. The memory 1660 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1660 may include software 1670 and/or firmware 1280. The memory 1660 may include suitably configured program code to be executed by the processor(s) 1650 so as to implement or configure the above-described functionalities for controlling beamforming, such as explained in connection with FIG. 4, 6, 10, or 12.

It is to be understood that the structures as illustrated in FIG. 12 are merely schematic and that the access node 1600 may actually include further components which, for the sake of clarity, have not been illustrated, e.g., further interfaces or further processors. Also, it is to be understood that the memory 1660 may include further program code for implementing known functionalities of a gNB in the NR technology or an eNB in the LTE technology. According to some embodiments, also a computer program may be provided for implementing functionalities of the access node 1600, e.g., in the form of a physical medium storing the program code and/or other data to be stored in the memory 1660 or by making the program code available for download or by streaming.

FIG. 17 illustrates a processor-based implementation of a wireless device 1700 which may be used for implementing the above-described concepts. For example, the structures as illustrated in FIG. 17 may be used for implementing the concepts in any of the above-mentioned UEs 10.

As illustrated, the wireless device 1700 includes one or more radio interfaces 1710. The radio interface(s) 1710 may for example be based on the NR technology or the LTE technology. The radio interface(s) 1710 may be used for providing connectivity of the wireless device to a wireless communication network, e.g., via one or more access nodes of the wireless communication network, such as the above-mentioned access nodes 101, 102, 103.

Further, the wireless device 1700 may include one or more processors 1750 coupled to the radio interface(s) 1710 and a memory 1760 coupled to the processor(s) 1750. By way of example, the radio interface(s) 1710, the processor(s) 1750, and the memory 1360 could be coupled by one or more internal bus systems of the wireless device 1700. The memory 1760 may include a ROM, e.g., a flash ROM, a RAM, e.g., a DRAM or SRAM, a mass storage, e.g., a hard disk or solid state disk, or the like. As illustrated, the memory 1760 may include software 1770 and/or firmware 1780. The memory 1760 may include suitably configured program code to be executed by the processor(s) 1750 so as to implement the above-described functionalities for controlling beamforming, such as explained in connection with FIG. 8 or 14.

It is to be understood that the structures as illustrated in FIG. 17 are merely schematic and that the wireless device 1700 may actually include further components which, for the sake of clarity, have not been illustrated, e.g., further interfaces, such as a dedicated management interface, or further processors. Also, it is to be understood that the memory 1760 may include further program code for implementing known functionalities of a UE. According to some embodiments, also a computer program may be provided for implementing functionalities of the wireless device 1700, e.g., in the form of a physical medium storing the program code and/or other data to be stored in the memory 1760 or by making the program code available for download or by streaming.

As can be seen, the concepts as described above may be used for efficiently controlling beamforming in scenarios involving access nodes with limited DL capability, such as a UL only node.

It is to be understood that the examples and embodiments as explained above are merely illustrative and susceptible to various modifications. For example, the illustrated concepts may be applied in connection with various kinds of wireless communication technologies. Further, the concepts may be applied with respect to various types of UEs. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-64. (canceled)

65. A method of controlling wireless communication, performed by an access node of a wireless communication network, the method comprising:
controlling a wireless device to perform a first uplink wireless transmission receivable by a further access node of the wireless communication network;
receiving, from the further access node, beamforming feedback related to the first uplink wireless transmission, wherein the beamforming feedback indicates at least one beamforming parameter to be applied by the wireless device in sending a second uplink wireless transmission, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
controlling, based on the received beamforming feedback, beamforming of the second uplink wireless transmission from the wireless device to the further access node by sending control data comprising the at least one beamforming parameter to the wireless device;
wherein the further access node is capable of receiving uplink wireless transmissions and is incapable of sending downlink wireless transmissions.

66. The method of claim 65, wherein the first uplink wireless transmission comprises at least one SRS.

67. The method of claim 65, wherein the beamforming feedback comprises at least one channel estimate based on the first uplink wireless transmission.

68. The method of claim 67, further comprising:
determining, based on the at least one channel estimate, at least one beamforming parameter to be applied by the wireless device in sending the second uplink wireless transmission; and
sending control data comprising the at least one beamforming parameter to the wireless device.

69. The method of claim 65, wherein the beamforming feedback comprises a signal representation of the first uplink wireless transmission.

70. The method of claim 69, further comprising:
determining, based on the signal representation, the at least one beamforming parameter to be applied by the wireless device in sending the second uplink wireless transmission; and
sending control data comprising the at least one beamforming parameter to the wireless device.

71. The method of claim 65, wherein the beamforming feedback is further based on interference of a third uplink wireless transmission to the first uplink wireless transmission.

72. A method of controlling wireless communication, performed by an access node of a wireless communication network, the method comprising:
receiving a first uplink wireless transmission from a wireless device;
determining beamforming feedback related to the first uplink wireless transmission, wherein the beamforming feedback indicates at least one beamforming parameter to be applied by the wireless device in sending a second uplink wireless transmission, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
sending the beamforming feedback to a further access node of the wireless communication network, wherein the beamforming feedback enables the further access node to control beamforming of the second uplink wireless transmission from the wireless device to the access node by sending control data comprising the at least one beamforming parameter to the wireless device;
wherein the access node is capable of receiving uplink wireless transmissions and is incapable of sending downlink wireless transmissions.

73. The method of claim 72, wherein the first uplink wireless transmission comprises at least one SRS.

74. The method of claim 72, wherein the beamforming feedback comprises at least one channel estimate based on the first uplink wireless transmission.

75. The method of claim 72, wherein the beamforming feedback comprises a signal representation of the first uplink wireless transmission.

76. The method of claim 72, further comprising:
receiving a third uplink wireless transmission from another wireless device; and
determining the beamforming feedback further based on interference of the third uplink wireless transmission to the first uplink wireless transmission.

77. A method of controlling wireless communication, performed by a wireless device, the method comprising:
performing a first uplink wireless transmission receivable by an access node of a wireless communication network;
receiving, in response to the first uplink wireless transmission, control data comprising at least one beamforming parameter from a further access node of the wireless communication network, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
performing, based on the received at least one beamforming parameter, a beamformed second uplink wireless transmission to the access node;
wherein the access node is capable of receiving uplink wireless transmissions and is incapable of sending downlink wireless transmissions.

78. The method of claim 77, wherein the first uplink wireless transmission comprises at least one SRS.

79. An access node of a wireless communication network, the access node comprising:
at least one processor; and
a memory containing program code executable by the at least one processor;
wherein execution of the program code by the at least one processor causes the access node to:
control a wireless device to perform a first uplink wireless transmission receivable by a further access node of the wireless communication network;
receive, from the further access node, beamforming feedback related to the first uplink wireless transmission, wherein the beamforming feedback indicates at least one beamforming parameter to be applied by the wireless device in sending a second uplink wireless transmission, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
control, based on the received beamforming feedback, beamforming of the second uplink wireless transmission from the wireless device to the further access node by sending control data comprising the at least one beamforming parameter to the wireless device;
wherein the further access node is capable of receiving uplink wireless transmissions and incapable of sending downlink wireless transmissions.

80. An access node of a wireless communication network, the access node comprising:
at least one processor; and
a memory containing program code executable by the at least one processor;
wherein execution of the program code by the at least one processor causes the access node to:
receive a first uplink wireless transmission from a wireless device;
determine beamforming feedback related to the first uplink wireless transmission, wherein the beamforming feedback indicates at least one beamforming parameter to be applied by the wireless device in sending a second uplink wireless transmission, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
send the beamforming feedback to a further access node of the wireless communication network, wherein the beamforming feedback enables the further access node to control beamforming of the second uplink wireless transmission from the wireless device to the access node by sending control data comprising the at least one beamforming parameter to the wireless device;
wherein the access node is capable of receiving uplink wireless transmissions and is incapable of sending downlink wireless transmissions.

81. A wireless device for operation in a wireless communication network, the wireless device comprising:
at least one processor; and
a memory containing program code executable by the at least one processor;
wherein execution of the program code by the at least one processor causes the wireless device to:
perform a first uplink wireless transmission receivable by an access node of the wireless communication network;
receive, in response to the first uplink wireless transmission, control data comprising at least one beamforming parameter from a further access node of the wireless communication network, wherein the at least one beamforming parameter comprises a Transmission Configuration Indicator (TCI) State identifier, a Transmitted Precoding Matrix Indicator (TPMI), a Sounding Reference Signal (SRS) Resource Indicator (SRI), and/or a Transmission Rank Indicator (TRI); and
perform, based on the received at least one beamforming parameter, a beamformed second uplink wireless transmission to the access node;
wherein the access node is capable of receiving UL wireless transmissions and is not capable of sending DL wireless transmissions.
